(19) United States
(12) Patent Application Publication
(10) Pub. No.: US 2006/0075841 A1
(43) Pub. Date: Apr. 13, 2006

(54) Actuator in a motor vehicle

(75) Inventors: Checrallah Kachouh, Dortmund (DE); Josip Stefanic, Odenthal (DE); Joerg Reinert, Remscheid (DE)

Correspondence Address: ROBERTS, MLOTKOWSKI & HOBBES, P. O. BOX 10064, MCLEAN, VA, 22102-8064, US

(73) Assignee: Brose Schliesssysteme GmbH & Co. KG, Wuppertal (DE)

(21) Appl. No.: 11/211,436

(22) Filed: Aug. 26, 2005

(30) Foreign Application Priority Data
Oct. 11, 2004 (DE) 20 2004 015 779.9

(51) Int. Cl. F16H 1/16

(52) U.S. Cl. 74/425

(57) ABSTRACT

An actuator for a motor vehicle has a drive motor, an actuating element and a blocking element. The blocking element can be deflected by the actuating element, against pretensioning, into a blocking position in which the blocking element blocks further movement of the actuating element. For this deflection, the blocking element is equipped with a tappet and the actuating element is equipped with a power transmission element. The actuating element is equipped with a stop and the blocking element is equipped with an counter-stop for blocking. Before the blocking is produced, the power transmission element releases the tappet, and after release, the blocking element, driven by its pretensioning, causes its counter-stop to fall onto the stop of the actuating element in a catch position.

### BACKGROUND OF THE INVENTION

1. Field of Invention

This invention relates to an actuator in a motor vehicle with a drive motor and a rotary actuating element which is driven by the drive motor in actuating cycles and with a pivoting blocking element which is pre-tensioned into an initial position, the blocking element having a tappet which engages a power transmission element on the actuating element during an actuating cycle, so that the blocking element is moved toward the blocking position. As the actuating cycle continues, a stop on the actuating element engages an counter-stop on the blocking element to block it, so that further movement of the actuating element is blocked, and during the actuating cycle and before blocking of the actuating element, the power transmission element releases the tappet, and the blocking element, unhindered by the power transmission element, being able to pivot toward its initial position.

2. Description of Related Art

An actuator in a motor vehicle is designed, for example, for seat adjustment, for a window raiser, or for a motor vehicle lock, for example, for triggering various functions such as double lock, child safety, center lock and unlock.

The prior art discloses an actuator of a motor vehicle lock (U.S. Pat. No. 6,889,571) with which two end positions of an actuating element can be reproducibly approached, and with which manual movement between these two end positions possible. The end positions are approached in block operation. For this purpose, there is an adjustable blocking element which can be moved into the path of motion of the actuating element. For exact adjustment of the blocking element, there is a complex control mechanism with a cam control. It is expensive and susceptible to faults.

The prior art which forms the starting point of this invention (German Patent Application DE 199 27 842 A1) discloses an actuator which has a rotary actuating element and a pivoting blocking element. The blocking element is pre-tensioned into its initial position and has a tappet which engages a power transmission element which is located on the actuating element during an actuating cycle. In this way, the blocking element is moved in the direction of the blocking position. As the actuating element continues to move, the power transmission element releases the tappet so that the blocking element, unhindered by the power transmission element, can pivot back basically in the direction of its initial position. However, further motion of the actuating element proceeds so quickly that the stop of the actuating element, which is formed here by the power transmission element, engages a counter-stop of the blocking element. In this way, the rotation of the actuating element is blocked and the blocking element is kept in the blocking position by friction.

After blocking of the actuating element, the drive motor which drives the actuating element is turned off, and the blocking element, due to its pretensioning pivots back into its initial position. In this way, it is possible for the actuating element to continue to run for another actuating cycle in the same direction of motion until it again engages the blocking element to block it.

The aforementioned actuator is not optimum in that reliable blocking of the actuating element requires a high driving speed. If the actuating element is turned too slowly, the blocking element prematurely returns from the blocking position into the initial position so that blocking of the actuating element does not occur.

### SUMMARY OF THE INVENTION

A primary object of this invention is to devise an actuator which is optimized with respect to reaching its blocking position.

The aforementioned object is achieved in that an actuator, after release of the tappet and before blocking of the actuating element, the blocking element, driven by its pretensioning, with its counter-stop falls onto the stop of the actuating element into a catch position.

The underlying advantage of the invention is that the actuating element, regardless of the speed of its motion during one actuating cycle, engages the blocking element so as to block it. This is accomplished in that the blocking element, after release of the tappet, driven by its pretensioning, with its counter-stop falls onto the stop of the actuating element into a catch position. This catching of the blocking element, first of all, causes engagement between the stop of the actuating element and the counter-stop of the blocking element. In a preferred configuration, the catch position is at the same time the above addressed blocking position so that the actuating element is blocked instantaneously after catching of the blocking element. Another preferred configuration, conversely, calls for the further movement of the actuating element out of this state to first cause pivoting of the blocking element into the blocking position by the engagement between the stop and opposing stop.

The above described catching of the blocking element, in any case, precludes the blocking element, after release of the tappet, from pivoting back into its initial position without having blocked the actuating element beforehand. In this way, especially high operating reliability of the actuator is achieved.

Preferably, the blocking element which is in the blocking position with the drive motor turned off is reset due to its pretensioning in the direction of its initial position. Due to the engagement between the stop and the opposing stop, the actuating element is then reset slightly against the previous direction of motion so that the blocking element can swivel unhindered into its initial position. The actuating element is therefore reset at least to such an extent that the blocking element is no longer held by the stop of the actuating element. In this way, it finally becomes possible for the actuating element to be able to turn in the same direction of motion as before. In particular, the stop of the actuating element and/or the counter-stop of the blocking element have a corresponding approach bevel for the aforementioned resetting of the actuating element.

In one preferred version the power transmission element located on the actuating element is at the same time the stop of the actuating element. This enables especially simple and favorable production of the actuating element.

The invention is explained in detail below with reference to the accompanying drawings. In the course of these explanations, other configurations and developments, and other features, properties, aspects and advantages of the invention will become apparent at the same time.

### BRIEF DESCRIPTION OF THE DRAWINGS

FIG. 1 shows an actuator of a motor vehicle with the blocking element in the initial position,

FIG. 2 shows the actuator from FIG. 1 with the blocking element in the blocking position,

FIG. 3 shows an extract of the actuator from FIG. 2, the power transmission element having released the tappet,

FIG. 4 shows a second embodiment with the blocking element in the blocking position,

FIG. 5 shows a third embodiment with the blocking element in the initial position,

FIG. 6 shows the actuator from FIG. 5 with the blocking element in the first blocking position,

FIG. 7 shows the actuator from FIG. 5 with the blocking element in the second blocking position,

FIG. 8 shows a fourth embodiment in a representation as shown in FIG. 5,

FIG. 9 shows a fifth embodiment in a representation as shown in FIG. 2.

### DETAILED DESCRIPTION OF THE INVENTION

In the figures of the drawings, the same reference numbers are used for the same or similar parts. Thus it should become clear that the corresponding or comparable properties and advantages are achieved even if a repeated description of these parts is omitted.

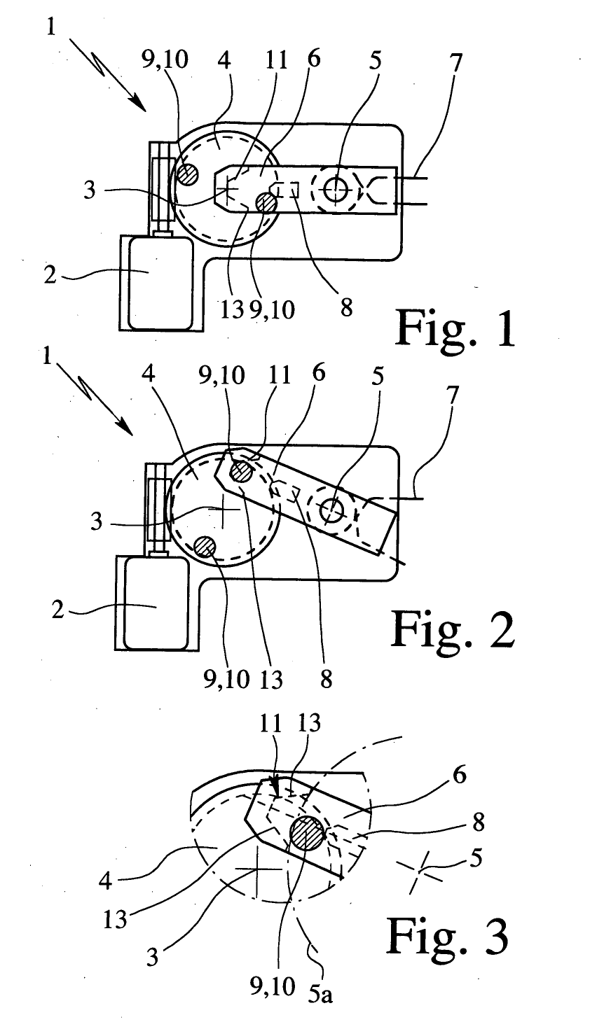

FIG. 1 shows an actuator 1 as is conventionally used in a motor vehicle. The actuator 1 has a drive motor 2, an actuating element 4 which can turn about axis of rotation 3, and a blocking element 6 which can be swing around pivot axis 5. The actuating element 4 is driven by the drive motor 2 in actuating cycles which end with blocking of the actuating element 4 by the blocking element 6. The blocking element 6 has an initial position which is shown in FIG. 1 and into which it is pre-tensioned. The pretensioning is caused by a spring 7 in the embodiment shown here. However, it can also take place by an elastic execution of the blocking element 6 or in some other way. When the blocking element 6 is made elastic, pivoting of the blocking element 6 is also defined as bending out of the initial position.

The blocking element 6 has a tappet 8 and the actuating element 4 has a power transmission element 9. During an actuation cycle of the actuating element 4, the tappet 8 of the blocking element 6 engages the power transmission element 9 of the actuating element 4. In this way, the blocking element 6 is moved toward the blocking position, as is shown in FIG. 2. As the actuation cycle continues, a stop 10 of the actuating element 4, which is formed here by the power transmission element 9, engages an counter-stop 11 of the blocking element 6 to block it, by which the further displacement of the actuating element 4 is blocked.

During one actuating cycle of the actuating element 4 and even before blocking of the actuating element 4, the power transmission element 9 releases the tappet 8. Then, the blocking element 6, driven by its pretensioning in the direction of the initial position with its counter-stop 11, falls onto the stop 10 of the actuating element 4 into the catch position (not shown). The catch position ensures that the actuating element 4, regardless of its speed of motion, can engage the blocking element 6 to block it.

If the tappet 8 has been released during the actuating cycle, the stop 10 of the actuating element 4 lies in the path of motion of the counter-stop 11 of the blocking element 6 to implement the catch position.

The illustration in FIG. 3 corresponds to the instant of the actuating cycle in which the tappet 8 is just being released. The circular segment 5a, shown there around the pivot axis 5 of the blocking element 6, represents the path of motion of one edge of the counter-stop 11 on the blocking element 6 which intersects the stop 10 on the actuating element 4; this constitutes a prerequisite for the aforementioned catch position.

One actuating cycle of the actuating element 4 up to blocking of the actuating element 4 is associated with the movement of the actuating element 4 in one direction of rotation. In this respect, it is not necessary to switch the drive motor 2 to another direction of rotation.

After blocking of the actuating element 4, the drive motor 2 is turned off. This conventionally takes place by monitoring the torque, preferably in the form of current monitoring of the electrical drive motor 2 and/or by a timing circuit, the time however having to be made relatively long so that the blocking position is in fact reached.

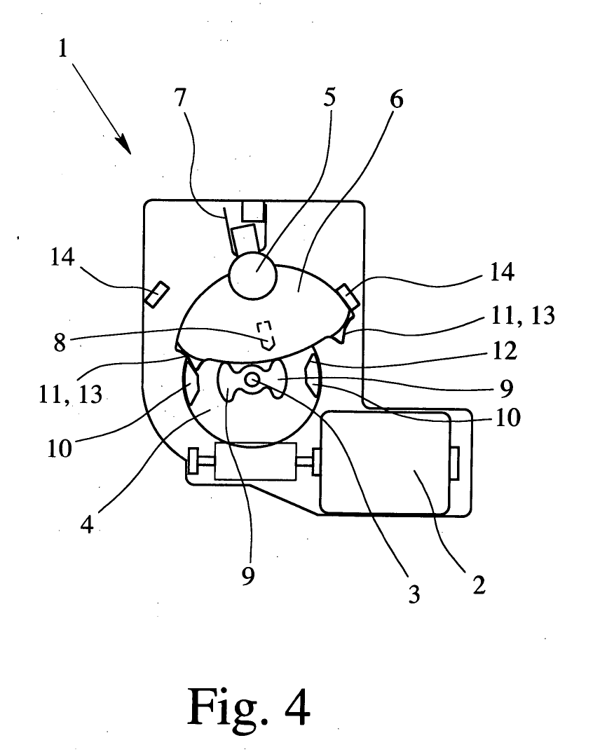

When the blocking element 6 is now in the catch position, further movement of the actuating element 4 during the actuating cycle preferably causes pivoting of the blocking element 6 into the blocking position. The stop 10 can have an approach bevel 12 for this purpose (see, FIG. 4) and the counter-stop 11 can have a corresponding additional approach bevel 13 for this purpose. However, it is also possible that either only the stop 10 has such an approach bevel 12 or only the counter-stop 11 has such an approach bevel 13 (FIGS. 1-3) or that the pivoting of the blocking element 6 into the blocking position is accomplished in some other way. Moreover, it is also possible for the catch position itself to be the blocking position, and accordingly, further pivoting of the blocking element 6 out of the catch position is not necessary at all.

When the blocking element 6 is in the blocking position and the drive motor 2 is turned off, resetting of the blocking element 6 in the direction of its initial position is associated with slight resetting of the actuating element 4 counter to the original direction of motion so that the blocking element 6 can finally pivot unhindered into its initial position. For this purpose, the stop 10 and the counter-stop 11 or one of these two elements (FIGS. 1-3) preferably in turn have the corresponding approach bevels 12, 13. The actuating element 4 is then not made self-locking in order not to prevent resetting. The resetting of the blocking element 6 and the associated minor resetting of the actuating element 4 are caused here preferably by the pretensioning of the blocking element 6 into its initial position.

In the embodiment shown in FIGS. 1-3, the power transmission element 9 of the actuating element, as already indicated, is preferably at the same time the stop 10 of the actuating element 4. This enables especially simple and economical manufacture of the actuating element 4. The power transmission element 9 is preferably made as a journal. However, it can also be made as a profile or the like.

The axis 3 of rotation of the actuating element 4 and the pivot axis 5 of the blocking element 6 are arranged parallel to one another and spaced apart from one another. This enables a simple, flat construction which is advantageous with respect to the necessary installation space.

The blocking element 6 here can preferably be pivoted out of its initial position in two directions. In the two pivot directions, it has one blocking position. The actuating element 4 can accordingly be moved bi-directionally so that the actuating element 4 can be blocked in the two directions of motion by the blocking element 6.

Alternatively, it is however also possible for the blocking element 6 to be able to pivot out of its initial position in only one direction. Depending on the functional necessity and existing installation space, this embodiment is preferred since it is accordingly more compact.

The blocking element 6 is made here as a lever with a lengthwise axis. The tappet 8 is located here on the lengthwise axis between the counter-stop 11 and the pivot axis 5 (FIGS. 1-3). Preferably, the blocking element 6 is made symmetrical with respect to its lengthwise axis. This enables especially a simple configuration of the two blocking positions for the different pivoting directions.

Moreover, the actuating element 4 is made symmetrical preferably with respect to a line of symmetry which intersects its axis of rotation 3. This is especially advantageous in connection with the aforementioned symmetrical blocking element 6 and the bidirectional triggering of the actuating element 4.

The counter-stop 11 of the blocking element 6 is made preferably as an essentially V-shaped catch pocket which is formed from the approach bevels (FIG. 1). The opening of the catch pocket is aligned with the tappet 8 so that the power transmission element 9, proceeding from the catch position, runs into the catch pocket as the actuating element 4 continues to move.

The actuating element 4, in the preferred embodiment shown in FIGS. 1-3, has two power transmission elements 9. The power transmission elements 9 are arranged offset to one another by roughly 180° with respect to the axis of rotation 3 of the actuating element 4. Accordingly, for actuation or triggering of functions shorter movements of the actuating element 4 are necessary than would be the case with only one power transmission element 9. Depending on the application, there can also be more than two power transmission elements 9.

The blocking element 6 is preferably arranged such that the lengthwise axis of the blocking element 6, in its initial position, intersects the axis of rotation 3 of the actuating element 4. With respect to symmetry and especially for two blocking positions, this is also advantageous. Furthermore, the blocking element 6 is configured and arranged such that its counter-stop 11, when the blocking element 6 is in the initial position, does not lie in the path of motion of the actuating element 4. The motion of the actuating element 4 can thus take place unhindered by the blocking element 6 until the tappet 8 engages the power transmission element 9.

FIG. 4 shows a second embodiment to which the aforementioned explanations of the first embodiment essentially apply. The actuator 1 is shown with the blocking element 6 in the blocking position and with the actuator 4 blocked.

In addition, it can be taken from FIG. 4 that the counter-stop 11 of the blocking element 6 does not overlap the actuating element 4 as long as the blocking element 6 is in its initial position. This is especially advantageous since this reduces the danger of hindering other functions.

Furthermore, in this embodiment, the power transmission element 9 of the actuating element 4 is made as a control cam. Moreover, the blocking element 6 has a first and second counter-stop 11 to which a first and a second stop 10 on the actuating element 4 are assigned. In this way, two blocking positions for the opposite directions of motion of the actuating element 4 are provided in this embodiment.

The stop 10 of the actuating element 4 is located as far as possible to the outside with respect to the axis 3 of rotation of the actuating element 4 in order to require a stopping force that is as small as possible. Preferably, the stop 10 is located in the outer third of the actuating element 4.

Conversely, the power transmission element 9 is located as far as possible to the inside with respect to the axis 3 of rotation of the actuating element 4. This enables high multiplication between the actuating element 4 and blocking element 6 so that a correspondingly low torque on the actuating element 4 is necessary for movement of the blocking element 6. Here, there is the special advantage of three-dimensional separation of the power transmission element 9 and stop 10, specifically design of these two components according to requirements.

The actuating element 4 and the blocking element 6 are preferably arranged such that the blocking force between the stop 10 and counter-stop 11 causes compressive loading in the blocking element 6. This is especially favorable with respect to the material loading in the area of the stop 10 and counter-stop 11.

Furthermore, the actuator 1 has a damper 14 for the blocking element 6 in the respective blocking position (FIG. 4). The damper 14 is made and arranged such that motion of the blocking element 6 is also acoustically damped in the blocking position in any case. The damper 14 is used here to reduce noise.

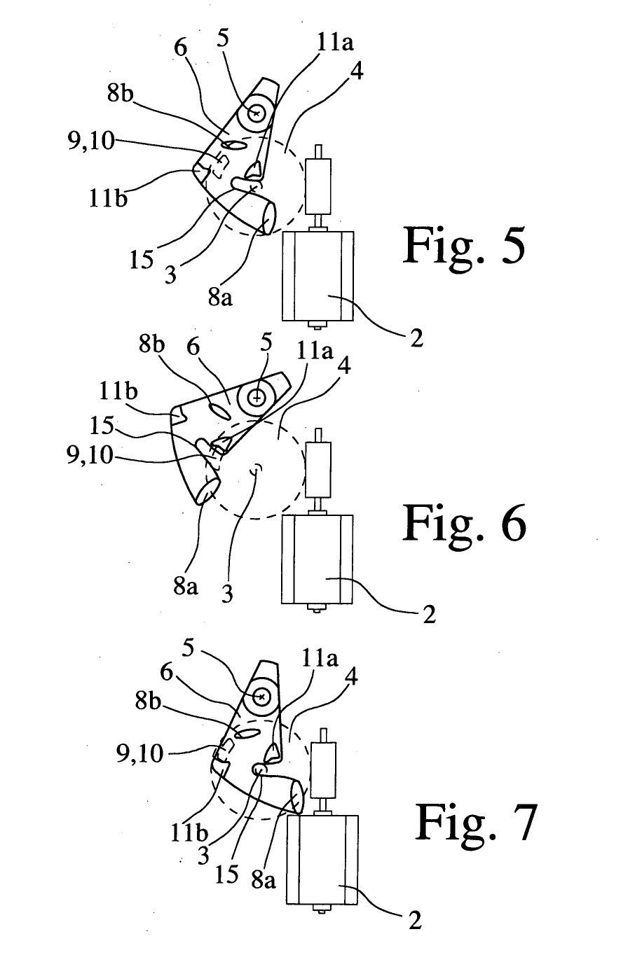

FIGS. 5-7 show another embodiment which follows the same principle as described above, in which the blocking element 6, in contrast to the previous embodiments, is however not made symmetrical. The aforementioned description applies accordingly to this embodiment. Here, it should be pointed out that FIGS. 5-7 are rough schematics from which the size relationship which may be necessary for operation cannot be taken.

The aforementioned, nonsymmetrical configuration is advantageous in that an especially compact configuration which is adapted to the respective conditions of the installation space is possible with it.

In the preferred embodiment shown in FIGS. 5-7, the blocking element 6 has several tappets 8, here exactly two tappets 8a, 8b and two opposing stops 11a, 11b. One of the tappets 8a, 8b is assigned to each counter-stop 11a, 11b and each of the opposing stops 11a, 11b is assigned to one direction of motion of the actuating element 4.

FIG. 6 shows the blocking element 6 in the first blocking position which is reached by the actuating element 4 being turned out of the initial position (FIG. 5) around to the right (clockwise). The power transmission element 9, here, first passes the tappet 8b during short, nonfunctional pivoting of the blocking element 6 around to the right in the drawings. Then, the power transmission element 9 engages the tappet 8a and presses the blocking element 6 in the direction of the first blocking position. As the actuating element 4 continues to move, the power transmission element 9 releases the tappet 8a and the blocking element 6 with its counter-stop 11a falls onto the stop 10 of the actuating element 4, the stop 10, as in the first embodiment, being formed by the power transmission element 9. Depending on the configuration of the stop 10 and counter-stop 11a, the actuating element 4 is now directly blocked, or as described above, blocked after a small further displacement.

In FIG. 7, the actuating element 6 has been turned counterclockwise out of the initial position so that the power transmission element 9 has engaged the tappet 8b of the blocking element 6 after passage of the tappet 8a and is now engaged to the counter-stop 11b to block it.

Another difference from the preceding embodiments, here, is that the blocking element 6 has a recess 15 which is shaped and arranged such that the blocking element 6 can be pivoted independently of the support of the actuating element 3 beyond the axis of rotation 3 of the actuating element 4 until the corresponding blocking position is reached.

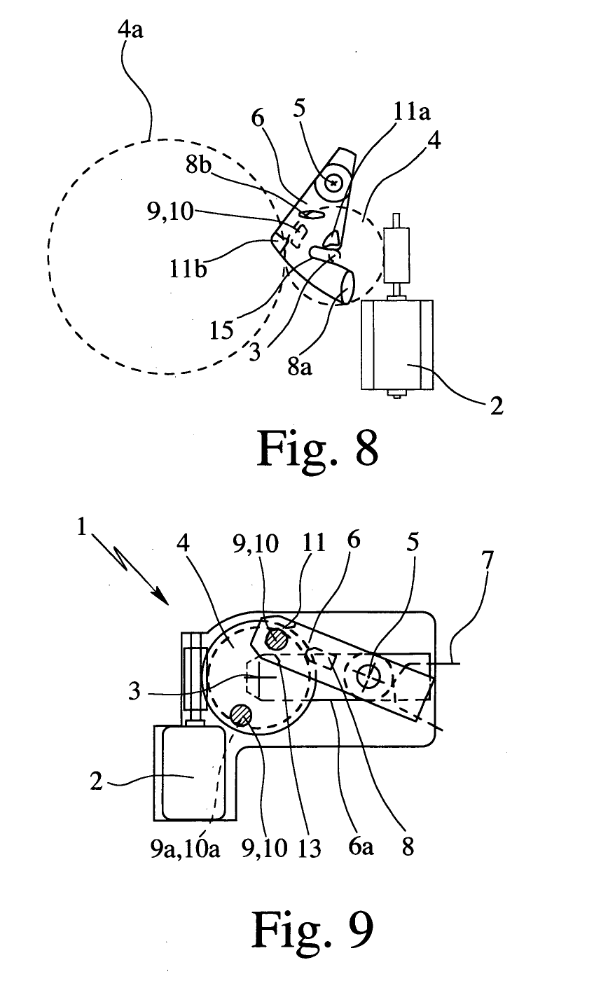

Regardless of the selected embodiment, it is advantageous to couple the actuating element 4 to another actuating element 4a for stepping down the rpm (FIG. 8). The other actuating element 4a is then used to release the actuating movements of the actuator 1. For example, for a 3:1 step-down, three revolutions of the actuating element 4 are necessary to achieve one revolution of the other actuating element 4a. The embodiments shown in FIGS. 1 to 4 thus require six actuating cycles with always the same direction of rotation for one complete revolution of the other actuating element 4a. Thus, the originally two approachable positions of the actuating element 4 have been converted into six positions of the other actuating element 4a. It should be pointed out that this multiplication of positions to be approached is possible by actuating cycles which follow one another in the same direction of rotation of the actuating element 4 being possible with the actuator 1 of the invention.

It is pointed out that, in the actuator 1, basically, the actuating movements of the actuating element 4 are used to trigger the respective function. Then, the actuating element 4 is coupled to the transmission elements (not shown) for relaying the actuating movements. Alternatively or in addition, it can be provided that the displacement of the blocking element 6 is used in the aforementioned sense as an actuating movement. This can lead to an especially high function density as a result.

As explained above, it is possible to move the actuating element 4 in only a single direction of rotation. A limitation is not intended here. Rather, in all the illustrated embodiments, there is bidirectional movement of the actuating element 4.

Regardless of the selected embodiment, it is also possible for another blocking element 6a to be assigned to the actuating element 4. The actuating element 4, then, has at least one other power transmission element 9a and another stop 10a for engaging the other blocking element 6a. Here, it can also be provided, as before, that the power transmission element 9a forms the stop 10a. The two blocking elements 6, 6a are preferably located on opposite sides of the actuating element 4 (shown schematically in FIG. 9). For the further configuration and manner of operation of both the actuating element 4 and also the blocking elements 6, 6a reference is made to the aforementioned description of individual embodiments. This arrangement is especially advantageous since a further degree of freedom arises for actuating several functions with only one actuating element 4 without the danger of mutual hindrance. This applies especially when the movements of the two blocking elements 6, 6a are used as actuating movements in the aforementioned sense.

The actuator 1 is especially suited here as a component of a motor vehicle lock.

Furthermore, it is preferred that the vehicle lock has a lock mechanism with several operating states, such as, for example, double lock, child safety, center lock and unlock, and that the lock mechanism can be switched into one or more operating states by means of the actuating element 4.

What is claimed is:

1. Actuator in a motor vehicle, comprising:
a drive motor,
a rotary actuating element with a power transmission element thereon and which is driven by the drive motor in actuating cycles, and
a pivoting blocking element which is pre-tensioned into an initial position, the blocking element having a tappet which engages the power transmission element during an actuating cycle so as to be moved in a direction toward a blocking position and a counter-stop which engages a stop on the actuating element during continuation of the actuating cycle, thereby blocking further movement of the actuating element, and during the actuating cycle and before blocking of the actuating element, the power transmission element releasing the tappet, and the blocking element, unhindered by the power transmission element, being able to pivot toward said initial position,
wherein, after release of the tappet and before blocking of the actuating element, the blocking element, driven by its pretensioning, engages the counter-stop onto the stop of the actuating element in a catch position.

2. Actuator as claimed in claim 1, wherein, during the actuating cycle and after release of the tappet, the stop of the actuating element lies in the path of motion of the counter-stop of the blocking element to implement the catch position.

3. Actuator as claimed in claim 1, wherein the actuating cycle, up to blocking of the actuating element, is associated with movement of the actuating element in only one direction of rotation.

4. Actuator as claimed in claim 1, wherein after blocking of the actuating element, the drive motor is turned off.

5. Actuator as claimed in claim 1, wherein the catch position is also the blocking position.

6. Actuator as claimed in claim 1, wherein, during the actuating cycle, with the blocking element in the catch position, movement of the actuating element causes pivoting of the blocking element into the blocking position by the engagement between the stop and counter-stop, and wherein at least one of the stop and the counter-stop has an approach bevel for producing said pivoting.

7. Actuator as claimed in claim 1, wherein, when the blocking element is in the blocking position and when the drive motor is turned off, resetting of the blocking element toward the initial position causes a slight resetting of the actuating element by engagement between the stop and the counter-stop, wherein the blocking element can then be pivoted unhindered into said initial position, and wherein, for this purpose, at least one of the stop and the counter-stop has a corresponding approach bevel.

8. Actuator as claimed in claim 7, wherein the resetting of the blocking element and the resulting slight resetting of the actuating element are produced by the pretensioning of the blocking element.

9. Actuator as claimed in claim 1, wherein the power transmission element is also the stop of the actuating element.

10. Actuator as claimed in claim 1, wherein the blocking element is pivotable out of said initial position in two pivoting directions, and in the two pivoting directions it has a blocking position, and wherein the actuating element is movable bi-directionally.

11. Actuator as claimed in claim 1, wherein the blocking element is pivotable out of its initial position in only one direction.

12. Actuator as claimed in claim 1, wherein the blocking element is a lever with a lengthwise axis, wherein the tappet is located on the lengthwise axis between the counter-stop and a pivot axis of the blocking element, and wherein the blocking element is symmetrical with respect to said lengthwise axis.

13. Actuator as claimed in claim 1, wherein the counter-stop of the blocking element is an essentially V-shaped catch pocket, an opening of the catch pocket being oriented toward the tappet.

14. Actuator as claimed in claim 1, wherein the counter-stop of the blocking element, in said initial position, does not overlap the actuating element.

15. Actuator as claimed in claim 1, wherein the power transmission element is a control cam.

16. Actuator as claimed in claim 1, wherein the blocking element has a first and a second counter-stop to which a first and a second stop on the actuating element are assigned, respectively.

17. Actuator as claimed in claim 1, wherein the stop of the actuating element, with respect to the axis of rotation of the actuating element is located in an outer third of the actuating element, and wherein the power transmission element of the actuating element, with respect to said axis of rotation, is located in an inner third of the actuating element.

18. Actuator as claimed in claim 1, wherein the blocking element has two tappets.

19. Actuator as claimed in claim 1, wherein an rpm step-down actuating element is coupled to the actuating element, the step-down actuating element being adapted to release the actuating movements of the actuator.

20. Actuator as claimed in claim 1, wherein a second blocking element is provided and wherein the actuating element has at least a second power transmission element and a second stop for engaging the second blocking element.

21. Actuator as claimed in claim 20, wherein the two blocking elements are located on opposite sides of the actuating element.

22. Actuator as claimed in claim 1, wherein the actuator is a component of a motor vehicle lock.
